(19) United States
(12) Patent Application Publication
(10) Pub. No.: US 2021/0099364 A1
(43) Pub. Date: Apr. 1, 2021

(54) Interacting with a Database and Network Function

(71) Applicant: Telefonaktiebolaget LM Ericsson (publ), Stockholm (SE)

(72) Inventors: Maria Cruz Bartolomé Rodrigo, Madrid (ES); Antonio Alonso Alarcon, Madrid (ES)

(21) Appl. No.: 16/754,913

(22) PCT Filed: Oct. 12, 2018
(86) PCT No.: PCT/EP2018/077962

§ 371 Date: Apr. 9, 2020

(30) Foreign Application Priority Data
Oct. 17, 2017 (EP) 17382690.0

(51) Int. Cl. H04L 12/24; H04L 29/08

(52) U.S. Cl. CPC H04L 41/5041; H04L 67/16

(57) ABSTRACT

Embodiments disclosed herein include a method for interacting with a network function associated with a database. The method comprises sending a request to the network function, wherein the request specifies at least one function associated with a provider of the database. The request specifies the at least one function in a standard representation common to a plurality of database providers including the provider of the database, and the at least one function associated with the provider of the database comprises proprietary functionality of the database or a proprietary system to access the database.

At least some examples of the present disclosure relate to the technical field of methods and apparatus for interacting with a network function and/or a database.

### INTRODUCTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The 5th Generation (“5G”) System is being developed, documented in references [1] and [2], the contents of which are incorporated herein by reference. The 5G System takes the form of a SBA (Service Based Architecture) including a plurality of Network Functions, where each Network Function (NF) provides one or multiple services (as a producer NF) to one or multiple service consumers (each being a consumer NF). For example, a HTTP/REST (Representational State Transfer using HTTP) Application Programming Interface (API) can be used for interaction between producer services and consumer services. In some cases, a NF may include one or more consumer services and one or more producer services.

FIG. 1 shows an example of a roaming 5G system architecture. In the service based architecture of a 5G system, it is intended that a service provided by a service producer is used (e.g. consumed) by a service consumer. The number of services (or service instances) available in a 5G system is dynamic (due to, for example, scaling up or down, failures, programmed maintenance and/or other factors). The 5G system therefore envisages a Network Repository Function (NRF) that supports functionality including the following:
NF service registration and deregistration in the NRF;
discovery of NF services by a NF service consumer; and
authorization of NF service consumer access to a producer.

In a 5G architecture such as that shown in FIG. 1, a Unified Data Management (UDM) network function may store subscriber data in a database. In a layered architecture, UDM consists in a UDM Front End (UDM-FE) plus a database. FIG. 2 shows an example of UDR contents and consumer network services (e.g. in one or more network functions). As shown, the UDR contains subscription data, subscription policy data, data for exposure and application data, and interfaces via a Nudr interface with UDM-FE, PCF and NEF network functions. The structure shown in FIG. 2 is merely an example and the entities depicted may be organised in a different manner and/or use different interface(s).

The Nudr interface is defined for network functions, such as UDM FE, PCF and NEF, to access a particular view of the data stored and to read, update (including add, modify), and delete data, and to subscribe to notification of changes of relevant data from the UDR. Each Network Function accessing the UDR may be able to add, modify, update or delete only the data it is authorised to change. This authorisation may be performed on a per view and per NF consumer basis and potentially on a per UE, subscription and/or roaming agreement basis by the UDR.

Table 1 below shows an example of services defined for UDM, and related service operations.

TABLE 1

| | Service | Operation | Example |
|---|---|---|---|
| NF service | Operations | Semantics | Consumer(s) |
| Subscriber | Get | Request/Response | AMF, SMF, |
| Data | | | SMSF |
| Management | UpdateSubscribe | Subscribe/Notify | AMF, SMF, |
| | Request | | SMSF |
| | UpdateUnsubscribe | Subscribe/Notify | AMF, SMF, |
| | | | SMSF |
| | UpdateNotification | Subscribe/Notify | AMF, SMF, |
| | | | SMSF |
| UE context | Registration | Request/Response | AMF, SMF, |
| management | | | SMSF |
| | RemoveNotification | Subscribe/Notify | AMF, SMF, |
| | | | SMSF |
| | Deregistration | Request/Response | AMF, SMF, |
| | | | SMSF |
| | Get | Request/Response | NEF |
| | Update | Request/Response | AMF |
| UE | Request | Request/Response | AUSF |
| Authentication | | | |
| EventExposure | Subscribe | Subscribe/Notify | NEF |
| | Unsubscribe | | NEF |
| | Notify | | NEF |

For UDR only one service is defined with related service operations as shown below in Table 2.

TABLE 2

| | Service | Operation | Example |
|---|---|---|---|
| NF service | Operations | Semantics | Consumer(s) |
| Unified Data | query | Request/Response | UDM FE, PCF, |
| Management | | | Provisioning FE, |
| | | | NEF |
| | create | Request/Response | Provisioning FE, |
| | | | NEF |
| | delete | Request/Response | Provisioning FE, |
| | | | NEF |
| | update | Request/Response | Provisioning FE, |
| | | | UDM, FE, PCF, |
| | | | NEF |
| | subscribe | Subscribe/Notify | UDM FE, PCF |
| | notify | | UDM FE, PCF |

NOTE 1:
Whether the data model used by UDR services is standardized or not leaves to stage 3 for decision.
NOTE 2:
As defined in TS 23.335 [11] clause 4.2.2, A Provisioning Front End is an Application Front End for the purpose of provisioning the UDR for subscription data and/or policy data.

FIG. 3 shows an example of communications between a NF (e.g. NF service, NF service producer) and NRF for registration of a service (e.g. service in a NF, or NF service). In Step 1, the NF service (service producer) sends a service profile (e.g. NF service profile) to the NRF. In step 2, the NRF stores the NF profile. In Step 3, the NRF sends an acknowledgement as a response to the NF (service producer). The terms “NF service” and “NF service profile” may be interchanged with “service” and “service profile”.

A NF service profile may include the following information:
NF instance ID
NF type
PLMN ID
Network Slice related Identifier(s) e.g. S-NSSAI, NSI ID
FQDN or IP address of NF
NF capacity information
NF Specific Service authorization information
Names of supported services
Endpoint information of instance(s) of each supported service
Other service parameter(s), e.g., DNN, notification endpoint for each type of notification that the NF service is interested in receiving

FIG. 4 shows an example of communications between a NF service (NF consumer) and the NRF during a service discovery process. In Step 1, the service consumer (NF service tries to discover the available instances of a particular service in the network. The service consumer sends a discovery request to the NRF indicating:
NF Service Name,
NF Type of the expected NF instance
NF type of the NF consumer
Optionally it may indicate the S-NSSAI.

In step 2, the NRF searches the registered services for those that match the criteria in the discovery request. In Step 3, the NRF replies to the NF with a set of discovered NF instance(s) or NF service instance(s) (for example, these may indicate a FQDN or IP address for each service in the set) that include one, some or all of the services that match the criteria.

FIG. 5 shows an example of communications between a NF consumer and NF producer (e.g. service provider). The interaction between two Network Functions (Consumer and Producer) within this NF service framework follows two mechanisms.

In the first, “Request-response,” a Control Plane NF_B (NF Service Producer) is requested by another Control Plane NF_A (NF Service Consumer) to provide a certain NF service, which either performs an action or provides information or both. NF_B provides a NF service based on the request by NF_A. In order to fulfil the request, NF_B may in turn consume NF services from other NFs. In the Request-response mechanism, communication is one to one between two NFs (consumer and producer) and a one-time response from producer to a request from consumer is expected within a certain timeframe.

In the second, “Subscribe-Notify,” a Control Plane NF_A (NF Service Consumer) subscribes to NF Service offered by another Control Plane NF_B (NF Service Producer). Multiple Control Plane NFs may subscribe to the same Control Plane NF Service. NF_B notifies the results of this NF service to the interested NF(s) that subscribed to this NF service. The subscription request shall include the notification endpoint (e.g. the notification URL) of the NF Service Consumer to which the event notification from the NF Service Producer should be sent to. In addition, the subscription request may include notification request for periodic updates or notification triggered through certain events (e.g., the information requested gets changed, reaches certain threshold etc.).

A Control Plane NF_A may also subscribe to NF Service offered by Control Plane NF_B on behalf of Control Plane NF_C, i.e. it requests the NF Service Producer to send the event notification to another consumer(s). In this case, NF_A includes the notification endpoint of the NF_C in the subscription request.

### SUMMARY

According to an aspect of this disclosure, there is provided a method for interacting with a network function associated with a database. The method comprises sending a request to the network function, wherein the request specifies at least one function associated with a provider of the database. The request specifies the at least one function in a standard representation common to a plurality of database providers including the provider of the database, and the at least one function associated with the provider of the database comprises proprietary functionality of the database or a proprietary system to access the database.

According to another aspect of this disclosure, there is provided a method of interacting with a database. The method comprises, in response to receiving a request for a service, the request specifying at least one function associated with a provider of the database, interacting with the database based at least in part on the at least one function. The request specifies the at least one function using a standard representation common to a plurality of database providers including the provider of the database, and the at least one function associated with the provider of the database comprises proprietary functionality of the database or proprietary system to access the database

According to a further aspect of this disclosure, there is provided a computer program comprising instructions which, when executed on at least one processor, cause the at least one processor to carry out a method according to any of the above aspects. Another aspect comprises a carrier that contains the computer program, wherein the carrier comprises one of an electronic signal, optical signal, radio signal or computer readable storage medium. Another aspect comprises a computer program product comprising non transitory computer readable media having stored thereon the computer program.

According to another aspect of this disclosure, there is provided apparatus for interacting with a database. The apparatus comprises a sending module configured to send a request to the network function, wherein the request specifies at least one function associated with a provider of the database. The request specifies the at least one function in a standard representation common to a plurality of database providers including the provider of the database, and the at least one function associated with the provider of the database comprises proprietary functionality of the database or a proprietary system to access the database

According to a still further aspect of the present disclosure, there is provided apparatus for interacting with a database. The apparatus comprises an interaction module configured to, in response to receiving a request for a service, the request specifying at least one function associated with a provider of the database, interact with the database based at least in part on the at least one function. The request specifies the at least one function using a standard representation common to a plurality of database providers including the provider of the database, and the at least one function associated with the provider of the database comprises proprietary functionality of the database or proprietary system to access the database.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic illustration of an example of a roaming 5G system architecture;

FIG. 2 is a schematic illustration of an example of UDR contents and consumer network functions;

FIG. 3 is an illustration of an example of communications between a NF and NRF for registration of a NF service;

FIG. 4 is an illustration of an example of communications between a NF service and NRF during a service discovery process;

FIG. 5 is an illustration of an example of communications between a NF consumer and NF producer;

FIG. 6 is a flow chart of an example of a method for interacting with a network function associated with a database;

FIG. 7 is a flow chart of an example of a method for interacting with a database;

FIG. 8 is a schematic illustration of an example apparatus for interacting with a database;

FIG. 9 is a schematic illustration of an example apparatus for interacting with a database;

FIG. 10 is a schematic illustration of an example apparatus for interacting with a database;

FIG. 11 is a schematic illustration of an example apparatus 1100 for interacting with a database; and

FIG. 12 illustrates an example of communications between entities in a communications network during interaction with a database.

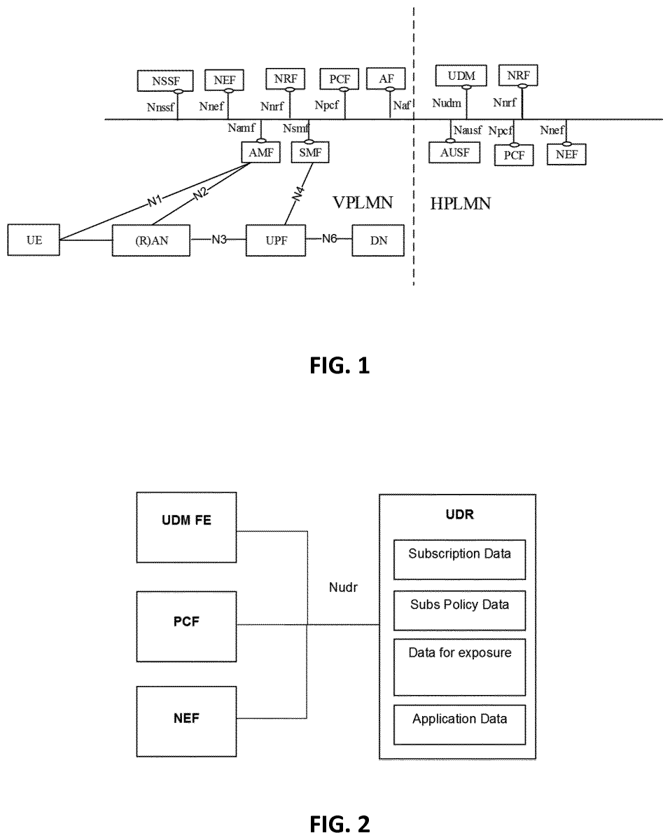

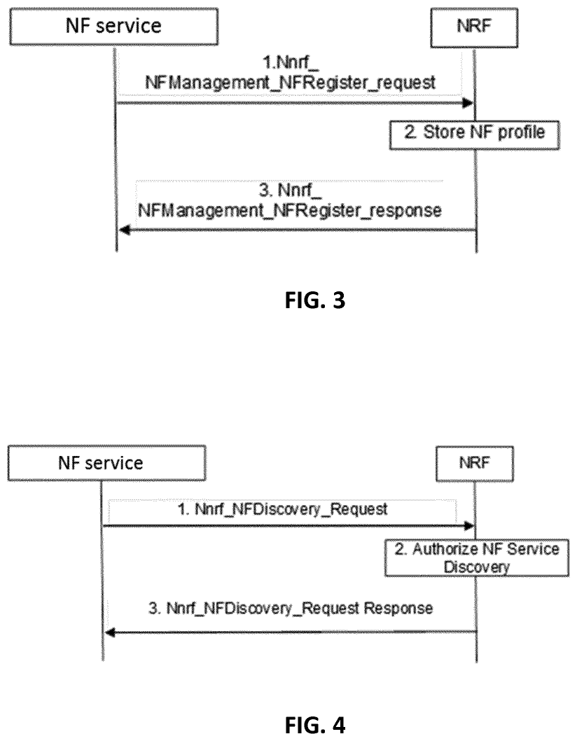

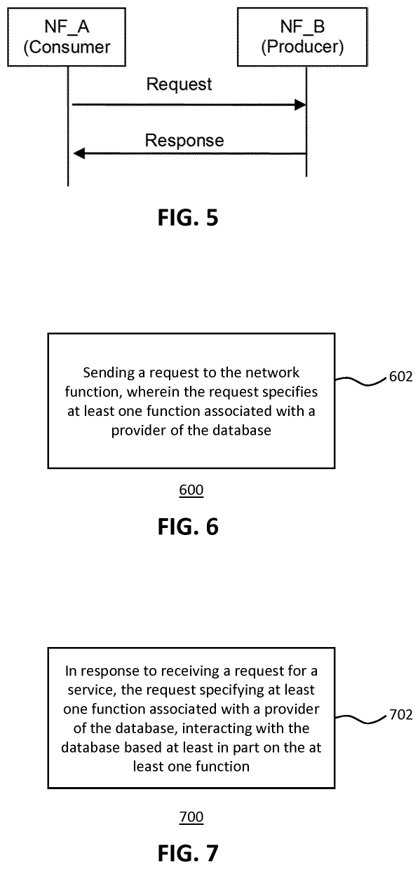

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

According to some embodiments of this disclosure, the UDR is not a unique entity in a network. For example, there may be multiple UDRs in a network in the following cases:
In customers' deployments, there may be multiple UDRs deployed in the same network, for example, in China where multiple regions are deployed.
Multiple UDRs to hold different data respectively.
Multiple UDRs to provide different services to different service consumers (e.g. PCF, UDM, NEF and/or other consumer(s)).

In these cases, each UDR in a network may register the UDM service in the NRF, but each UDM only serves some specific data, for example subscription data for just a part of all subscribers could be held by a first UDR, while a second UDR may hold the rest of subscribers; or the first UDR could store subscription data just for UDM-FE and PCF, while the second UDR stores Application Data and even a third UDR stores Data for Exposure.

This means that each UDR may register a producer service under the same name, (for example, “Unified Data Management”), but it is not possible to identify which data is accessed/served by that instance of the service. As a result, the consumer NF, e.g. UDM-FE, cannot obtain from discovery with the NRF the information to be able to select the UDR service instance that provides access to the data this consumer service is interested in.

The same problem applies to UDM when it stores locally the data (i.e. UDR as an external database is not deployed). If, for example, a UDM stores data for a group or range of subscribers, then UDM consumers (e.g. AMF, SMF, SMSF) do not know which UDM-FE instance stores data for the corresponding UE/subscriber.

In addition, at present it is not specified how service versions are handled, how vendor proprietary service functionality is handled, how vendor proprietary database (for storing any data in the 5G system) functionality is handled, or how service upgrades are handled.

FIG. 6 is a flow chart of an example of a method 600 for interacting with a network function associated with a database. The method 600 comprises, in block 602, sending a request to the network function, wherein the request specifies at least one function associated with a provider of the database. Therefore, for example, the request to the network function may specify functionality that is proprietary to the provider of the database, i.e. the functionality is the function associated with the provider of the database. In this way, the proprietary functionality may be specified in the request.

In some examples, the request may be formed in a standard format. For example, the request specifies the at least one function in a standard representation common to a plurality of database providers including the provider of the database. In some embodiments, for example, therefore, the request may be specified by a standard or be accepted by a plurality of network functions each associated with a database, and offering different proprietary functionality (which may include a standard function, or function similar to those offered by other DB vendors, but which is accessed using proprietary systems) via different functions specified in the request. In some examples, the request may be specified as part of an extensible standard that includes portions common to all network functions associated with databases, and may also specify proprietary extensions. In some examples, the at least one function is specified using at least one parameter-value pair.

In some examples, the at least one function is specified using JavaScript Object Notation (JSON). Some examples of the method 600 may then comprise converting the request specifying the at least one function using JSON to an Application Programming Interface (API) call for the function associated with the provider of the database. Sending the request to the network function may then comprise sending the converted request to the network function. Sending a request to the network function may comprise sending the request using a Nudr or Nudsf interface

The method may in some embodiments comprise receiving a response, the response based at least in part on the at least one function. In this way the response may include or be based on, for example, proprietary functionality of the network function or the database as offered by the provider of the database.

The request comprises in some embodiments a request for a service in relation to the database. In some examples, the at least one function associated with the provider of the database comprises proprietary functionality of the database or a proprietary system to access the database. The network function may comprise a Unified Data Repository (UDR), User Data Repository (UDR) or Unstructured Data Storage Function (UDSF).

The method may in some embodiments be implemented by a consumer network function. Therefore, for example, the request may be a request for a service.

FIG. 7 is a flow chart of an example of a method 700 for interacting with a database. The method comprises, in response to receiving a request for a service, the request specifying at least one function associated with a provider of the database, interacting with the database based at least in part on the at least one function. Thus, for example, interaction with the database may use proprietary functionality of the database offered by the provider of the database, as specified by the at least one function.

In some examples, the request specifies the at least one function using a standard representation common to a plurality of database providers including the provider of the database. Therefore, for example, another database provider may be able to parse the request including the at least one function, even if the other database provider does not offer the same (for example) proprietary functionality. The at least one function may be specified for example using at least one parameter-value pair. In some examples, the at least one function is specified using JavaScript Object Notation (JSON).

The method 700 may also include sending a response to a sender of the request for the service, the response based at least in part on the at least one function. The response may be for example based on or incorporate proprietary functionality offered by the database provider. The request may comprise a request for a service in relation to the database.

The at least one function associated with the provider of the database may comprise proprietary functionality of the database or proprietary system to access the database.

In some embodiments, interacting with the database based at least in part on the at least one function comprises translating the at least one function into database interaction commands, and providing the database interaction commands to the database. For example, the at least one function may be translated into API instructions or commands particular to that database, and hence adoption of a manner to specify for example the proprietary functionality that is different to the API may not require the API for the database to be redesigned.

In some embodiments, the method 700 includes, in response to receiving interaction results from the database, forwarding the interaction results to a sender of the request. Forwarding the interaction results to a sender of the request may in some examples include translating the interaction results into a standard format or standard representation. Thus the standard format or representation may be specified, for example, in a communications standard and thus may be understandable by a plurality of entities, including those offered by parties other than a provider of the database.

The method 700 may comprise receiving the request from a consumer network function. The method 700 may be implemented in a 5G system.

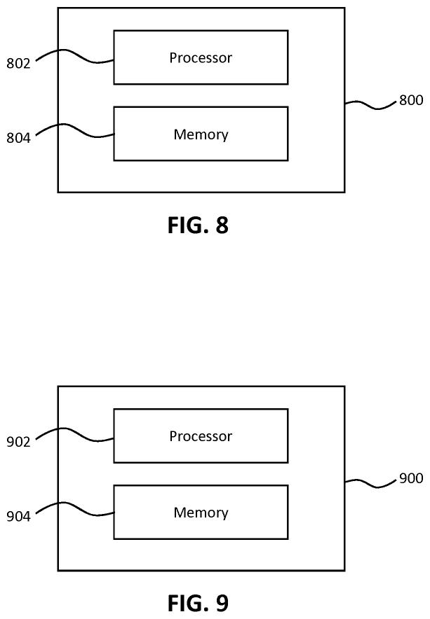

FIG. 8 is a schematic illustration of an example apparatus 800 for interacting with a database. The apparatus 800 comprises a processor 802 and a memory 804. The memory 804 containing instructions executable by the processor 802 such that the apparatus is operable to perform, for example, the method 600 of FIG. 6.

FIG. 9 is a schematic illustration of an example apparatus 900 for interacting with a database. The apparatus 900 comprises a processor 902 and a memory 904. The memory 904 containing instructions executable by the processor 902 such that the apparatus is operable to perform, for example, the method 700 of FIG. 7.

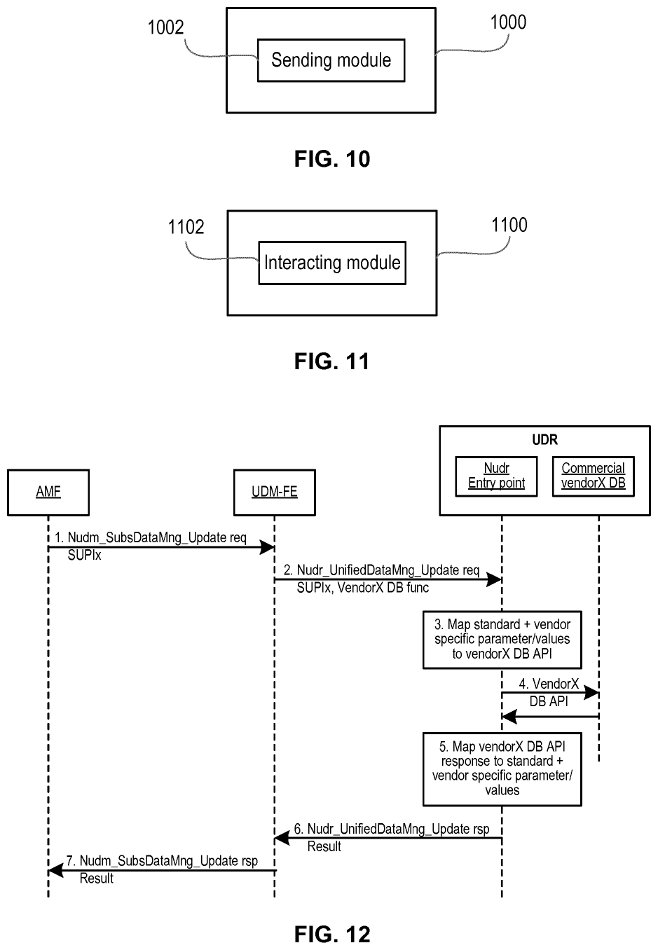

FIG. 10 is a schematic illustration of an example apparatus 1000 for interacting with a database. The apparatus 1000 comprises a sending module 1002 configured to send a request to the network function, wherein the request specifies at least one function associated with a provider of the database.

FIG. 11 is a schematic illustration of an example apparatus 1100 for interacting with a database. The apparatus 1100 comprises an interaction 1102 module configured to, in response to receiving a request for a service, the request specifying at least one function associated with a provider of the database, interact with the database based at least in part on the at least one function.

Further examples and embodiments will now be described.

Embodiments disclosed herein provide a system for using vendor database (DB)-specific functionality and capabilities as an extension of the standard API defined in 3GPP, in order to simplify integration of a database from a particular vendor.

Some embodiments disclosed herein define Nudsf and/or Nudr (and generically any standard interface to access to a DB) in a way to be extensible, to allow including a vendor specific definition of DB API functionality.

Each DB vendor in order to ease 3GPP NF/service consumers' integration may provide a definition of its specific DB APIs following the agreements for 3GPP API extensibility. For example, if Nudsf and/or Nudr are defined as HTTP/REST APIs, vendor specific JSON bodies in some examples may be allowed to be included.

Each DB vendor may then model their existing APIs following a JSON body (vendor specific). That is, for example, a particular JSON body may trigger a particular API and corresponding functionality. Then, a NF/Service that uses Nudr or Nudsf may implement a standard API and include the vendor specific JSON body, providing its preferences for functionality proprietary to the database from the vendor.

Some examples may then provide a conversion (e.g. translation) between this vendor specific JSON body to the real DB API calls. A conversion module for this purpose could be provided either by each DB vendor, or another party. In some examples, a JSON body may include a “standard” portion that is generic to DBs from most or all vendors, and a “proprietary” portion that is specific to the particular vendor. Alternatively, there may be a “standard” JSON body and a “proprietary” JSON body. In a more general sense, one or more JSON bodies may collectively specify “standard” functionality and “proprietary” functionality. For example, a JSON body to trigger or access a DB vendor's proprietary APIs may have a part that is proprietary, for proprietary functionality (exclusive of this DB vendor), but a part of a JSON body may be standard in a way that most or all DB vendors understand and provide related functionality (e.g. GeoRed functionality).

As an example use case, we can consider when AMF needs to update UE capabilities. This use case is illustrated for example in FIG. 12, which illustrates an example of communications between entities in a communications network during interaction with a database. The AMF may send updated information to a UDM-FE, using for example Nudm_SubsDataMng_Update operation, for one specific UE identity (e.g. SUPIx). HTTP/REST API for Nudm may be defined, and parameters and values for the particular database as offered by the vendor may be defined in a JSON body.

At initial set-up of UDM-FE, for example, a DB from a particular vendor is used to store data that is accessible by the UDM-FE. (As an alternative, multiple vendor DBs could provide service to different types of data or data ranges, then UDM-FE may be configured to identify the specific vendor for each case). Some parameters in the JSON sent to the UDM-FE, or from the UDM-FE to the database, may be filled by default, while others may vary dynamically based on e.g. NF type (e.g. UDM-FE, NEF . . . ), service (e.g. Nudm_UE Context Mng, Nudm_SubscriberDataMng), type of data (e.g. subscriber data, data for exposure, etc), type of DB request (e.g. query, update, etc), specific UEs or data records (e.g. by SUPI, data identifiers, etc).

As an example, taking Cassandra as the DB technology, a vendor-specific specific JSON body could allow UDR client (UDM-FE in this example use case) to define the desired “data consistency level” for Update operations. A different consistency level value could be defined for each Update operation (e.g. as at least one function in a request), and/or based on the particular consumer, and/or for some specific use cases. Each DB technology from each vendor may offer several options for “data consistency level,” such as, for example: local (to a data center) data consistency, wide (across data centers) data consistency, no particular data consistency required, or any other suitable parameter. In one example, UDM-FE could be configured (e.g.) to set this “data consistency level” to “wide data consistency”.

The UDR may implement a module/function to receive and process new Nudr requests. A part of this module or function may be able to parameters received in a Nudr JSON body (both standard ones plus the vendor-specific ones) into a specific API for the database from the vendor. There may then be a vendor/database-specific DB API request and response, for example, a query is provided to the database, and the DB returns the requested data.

A part of the module or function may be able to map parameters received as a response of the VendorX API execution, back to a result in a defined format, e.g. standard representation, etc. The result may then be included in acvresponse back to UDM-FE and then to AMF.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It should be noted that the above-mentioned examples illustrate rather than limit the embodiments disclosed herein, and that those skilled in the art will be able to design many alternative examples. The word “comprising” does not exclude the presence of additional elements or steps, “a” or “an” does not exclude a plurality, and a single processor or other unit may fulfil the functions of several units. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in statements shall not be construed so as to limit their scope.

1-27. (canceled)

28. A method for interacting with a network function associated with a database, the method comprising:
sending a request to the network function, wherein the request specifies at least one function associated with a provider of the database;
wherein the request specifies the at least one function in a standard representation common to a plurality of database providers including the provider of the database; and
wherein the at least one function associated with the provider of the database comprises proprietary functionality of the database or a proprietary system to access the database.

29. The method of claim 28, wherein the at least one function is specified using at least one parameter-value pair.

30. The method of claim 28, wherein the at least one function is specified using JavaScript Object Notation (JSON).

31. The method of claim 30, further comprising converting the request specifying the at least one function using JSON to an Application Programming Interface (API) call for the function associated with the provider of the database.

32. The method of claim 31, wherein the sending the request to the network function comprises sending the converted request to the network function.

33. The method of claim 31, wherein the sending the request to the network function comprises sending the request using a Nudr or Nudsf interface.

34. The method of claim 28, further comprising receiving a response, the response based at least in part on the at least one function.

35. The method of claim 28, wherein the request comprises a request for a service in relation to the database.

36. The method of claim 28, wherein the network function comprises a Unified Data Repository (UDR), User Data Repository (UDR), or Unstructured Data Storage Function (UDSF).

37. A method of interacting with a database, the method comprising:
in response to receiving a request for a service, with the request specifying at least one function associated with a provider of the database, interacting with the database based at least in part on the at least one function;
wherein the request specifies the at least one function using a standard representation common to a plurality of database providers including the provider of the database; and
wherein the at least one function associated with the provider of the database comprises proprietary functionality of the database or proprietary system to access the database.

38. The method of claim 37, wherein the at least one function is specified using at least one parameter-value pair.

39. The method of claim 37, wherein the at least one function is specified using JavaScript Object Notation (JSON).

40. The method of claim 37, further comprising sending a response to a sender of the request for the service, the response based at least in part on the at least one function.

41. The method of claim 37, wherein the request comprises a request for a service in relation to the database.

42. The method of claim 37, wherein the interacting with the database based at least in part on the at least one function comprises:
translating the at least one function into database interaction commands; and
providing the database interaction commands to the database.

43. The method of claim 37, further comprising, in response to receiving interaction results from the database, forwarding the interaction results to a sender of the request.

44. The method of claim 43, wherein the forwarding the interaction results comprises translating the interaction results into a standard format or standard representation.

45. The method of claim 37, further comprising receiving the request from a consumer network function.

46. An apparatus for interacting with a network function associated with a database, the apparatus comprising:
processing circuitry;
memory containing instructions executable by the processing circuitry whereby the apparatus is operative to:
send a request to the network function, wherein the request specifies at least one function associated with a provider of the database;
wherein the request specifies the at least one function in a standard representation common to a plurality of database providers including the provider of the database; and
wherein the at least one function associated with the provider of the database comprises proprietary functionality of the database or a proprietary system to access the database.

47. An apparatus for interacting with a database, the apparatus comprising:
processing circuitry;
memory containing instructions executable by the processing circuitry whereby the apparatus is operative to:
in response to receiving a request for a service, with the request specifying at least one function associated with a provider of the database, interacting with the database based at least in part on the at least one function;
wherein the request specifies the at least one function using a standard representation common to a plurality of database providers including the provider of the database; and
wherein the at least one function associated with the provider of the database comprises proprietary functionality of the database or proprietary system to access the database.
